(19) United States
(12) Patent Application Publication
(10) Pub. No.: US 2002/0120730 A1
(43) Pub. Date: Aug. 29, 2002

(54) Reliability for simple network management protocol trap messages

(76) Inventors: Daniel John Goudzwaard, Bolingbrook, IL (US); Matthew S. Hrycko, Addison, IL (US)

Correspondence Address: Werner Ulrich, 434 Maple Street, Glen Ellyn, IL, 60137-3826, US

(21) Appl. No.: 09/794,808

(22) Filed: Feb. 27, 2001

(51) Int. Cl. G06F 15/173; G06F 15/16

(52) U.S. Cl. 709/223; 709/237

(57) ABSTRACT

In a Broad Based Data System, one Manager System can control the actions of a plurality of Agent Systems. The Agent Systems communicate with the Manager System by sending trap messages. The Manager System ensures that no trap messages are lost by checking that a sequence number of each received trap message from a particular Agent System is one higher than a sequence number of a previously received trap message. If a missing sequence number is detected, the Manager requests re-transmittal of the message associated with that sequence number. In order to prevent flooding a Manager with an excessive number of trap messages from a particular Agent System, the Agent System can only send a given number, N of messages, before it is re-authorized to send more messages. In Applicants' specific embodiment, the authorization is in the form of an acknowledgment message. Trap messages representing alarm conditions are particularly important. Alarm conditions are saved as long as the alarm is active. In case of an interruption of communications between the Agent and the Manager, all trap messages associated with these saved active alarm conditions are transmitted to the Manager System. Advantageously, these arrangements provide reliable communications between the Agent and Manager Systems, especially for the important messages representing alarm conditions in the Agent.

### TECHNICAL FIELD

This invention relates to communications between Manager and Agent Systems served by a broad based data network such as the Internet.

### BACKGROUND OF THE INVENTION

A broad based data network, such as the Internet, is used to interconnect terminals connected to that network. Those terminals which are directly connected to the network are usually called Network elements. Any managed network element has a control entity called an Agent, which controls maintenance operations and traffic. It is necessary for such a network to provide management functions for controlling these Agents. In the case of the Internet, these management functions are provided from a Manager connected to the Internet. Communications between the Manager and the Agent are controlled by standards. The Manager maintains information concerning each Agent, including the present status, (e.g., in service, out of service, faulty). The parameters for each of the systems served by an Agent, (e.g., bandwidth, delay parameters and other parameters), define the service offered to each system connected to each Agent. The Manager also maintains a control table of the names and allowed value pairs of each of the network elements controlled by each Agent system, and permissions for changing these values. (For example, a Manager may not be permitted to change the hardware status of a network element controlled by an Agent, since that status is reported and is not directly controllable by the Manager; however, the Manager may be able to change the software status of the network element, and then request the Agent to change the hardware status). The arrangement of the information in the Manager's data is in accordance with the standards set by the Managed Information Base Standards.

The Manager and Agents communicate via messages sent over the Internet. The protocol for these messages is the Simple Network Management Protocol, (SNMP). This protocol uses the User Datagram Protocol/Internet Protocol (UDP/IP) for messages between the Manager and the Agent. The Manager sends information request messages (Get), and control information change messages (Set), to the Agent. The Agent also sends Get Response Messages and Set Response Messages, but these messages are not the subject of this invention. Further, the Agent sends trap messages to the Manager. The trap messages, in contrast to the Get Response and Set Response Messages, are generated autonomously by the Agent.

### SUMMARY OF THE INVENTION

Applicants have analyzed this arrangement, and have recognized that a major problem of this prior art is that trap messages are transmitted, using the UDP protocol, a protocol which is connectionless and does not have reliability features. The messages are transmitted over an Internet Protocol (IP) Network, one of whose links may become inoperative, thus breaking the path between an Agent and the Manger, or there may be a temporary overload condition on such a link as a result of some unusual bursts of data. Also, the Manager may be so overloaded that it cannot accept additional trap messages. These problems are especially serious when the messages being transmitted concern alarm conditions which usually result in transmission of trap messages. The selection of the UDP protocol is a standard, more than ten years old, and can, therefore, not be changed at the discretion of the particular manufacturer or service provider.

In accordance with Applicants' invention, arrangements are implemented for enhancing the reliability of transmission of trap messages without deviating from SNMP or the UDP protocol. Specifically, Applicants associate with each trap message, a sequence number, which is sent along with a trap message. When the Manager receives the trap message, the Manager checks whether the sequence number is one higher than the sequence number of the most recently received trap message from that Agent. If not, resynchronization is accomplished by having the Manager request that the missing messages, identified by the missing sequence numbers, be re-transmitted by transmitting one or more “Get” messages to the Agent to obtain the lost trap messages in the Get Response, or by requesting that the Agent re-transmit the missing trap messages, or transmit all trap messages from the message corresponding to the first lost sequence number. In order to allow this to happen, the Agent maintains a file of the most recently transmitted trap messages and their associated sequence numbers. Advantageously, this arrangement allows for re-transmission of trap messages whenever a trap message is lost. Advantageously, this arrangement also allows for re-transmission of trap messages that were properly received, but were lost in the Manager, because of some problem in that unit.

In accordance with one feature of Applicants' invention, the reliability of the transmission of messages from the Manager to the Agent is enhanced by requiring an audit consisting of a Manager retrieving the last transmitted sequence number from the Agent. If the sequence number of the response is not correct, it is a sign that resynchronization of the Agent must be carried out. The audit is run periodically if no trap messages have been received since a last audit. Advantageously, this arrangement ensures that all lost messages from the Manager to the Agent are detected and can be re-transmitted.

Another problem associated with the reliable transmission of trap messages is the problem of Manager overload. If the Manager receives more trap messages than it can process, it must discard some of these messages. The problem of Manager overload can be severe, especially if one Manager manages many Agents and/or if one Agent suddenly generates a large number of trap messages. In order to throttle trap message traffic, the Manager can instruct one or more of the Agents to send only trap messages having a priority higher than a requested severity, by simply requesting the Agent to send only Alarm type trap messages, or, in an extreme case, to stop all trap messages from one or more selected Agents. Advantageously, this arrangement throttles traffic with minimum impact on the basic structure of the Agent.

In accordance with an alternate implementation of the throttling feature of Applicants' invention, trap messages are throttled using a sliding window acknowledgment. Under this arrangement, no more than a pre-determined number of trap messages may be sent before an acknowledgment is received. In other words, if trap message “n” has been acknowledged, no more than “m” additional trap messages may be sent before another acknowledgment is received. In order to handle the situation in which relatively few trap messages are generated by a particular Agent, an acknowledgment is sent from the Manager after the first of two events: receipt of the “n” “m′th” trap message, or lapse of a pre-determined time interval since the last acknowledgment was sent. Advantageously, this arrangement prevents any particular Agent from overwhelming the Manager to the detriment of service to other Agents. A disadvantage of this arrangement is that extra messages, the acknowledgment messages, are required, thus decreasing the capacity of the Manager, the Agent, and the Network available for other work.

### BRIEF DESCRIPTION OF THE DRAWING(S)

FIG. 1 is a block diagram illustrating the operation of Applicants' invention;

FIGS. 2 and 3 are flow diagrams of operations performed in the Manager; and

FIG. 4 is a flow diagram of operations performed in the Agent.

### DETAILED DESCRIPTION

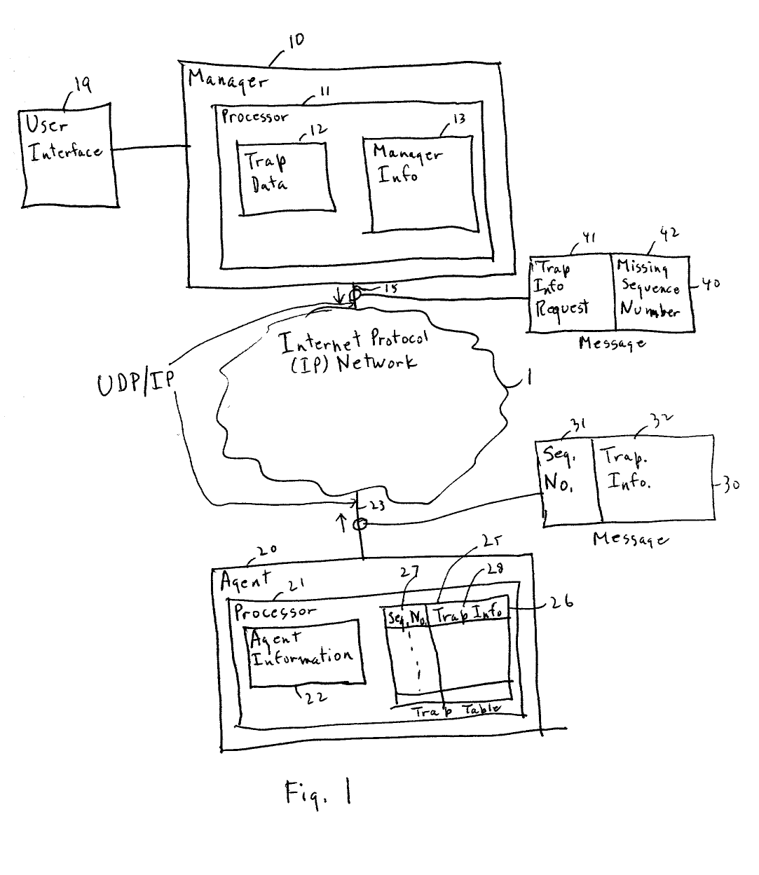

FIG. 1 is a block diagram illustrating the operation of Applicants' invention. An Internet Protocol (IP) Network interconnects a Manager (10) and a plurality of Elements or Agents, such as Agents 19, . . . , 20. Manager (10) is connected to a user interface (18) for displaying information for use by a Network Administrator. The Network Administrator can also provide commands to the Manager for the Manager to implement through the use of “Get” and “Set” messages.

The Manager includes an Element Manager Data Base (11), which contains data such as “received trap” data messages (12), Manager Information (13), and an Agent/Sequence Number Table (14), containing for each Agent an Expected Sequence Number and Acknowledge Sequence Number. The Acknowledge Sequence Number is the sequence number of the most recent Acknowledgment message, and the Expected Sequence Number is the sequence number of the next expected message. The Manager Information (13) is information stored in accordance with the rules of the Managed Information Block Standard, and includes information describing all units attached to all of the Agents served by the Manager, and including the present state and allowable values of that state, and parameters of each connected system. Agent (20) includes a Managed Information Data Base (MIB) 21. Stored in MIB (21) is Agent information (22) describing the present state and parameters for each of the systems connected to the Agent (not shown), and a table (25) of trap messages. For each trap message, such as trap message (26), the sequence number (27) and the trap message information (28) are stored in table (25). In addition, MIB (21) contains an Alarm Table (29), (a list of all alarm conditions retained until acknowledge messages clearly indicate that the alarm condition has been received). A trap sequence number (30) keeps track of the last trap message that was sent, and a last trap index (31) keeps track of the last trap message entered into table (25). An Acknowledge Sequence Number (32) is also maintained in the MIB.

The alarms in the Alarm Table are retained until the alarms clear. This allows the Manager to retrieve this vital information at any time; for example, after a catastrophic failure of the Manager, the Manager can retrieve alarm information lost during the failure. The Log Table only needs to keep unacknowledged trap messages.

When an Agent transmits a trap message over link (23) connected to the IP Network (1), it transmits a message, such as message (35), which includes a sequence number (36) and a trap information (37). This information is sent over the IP Network (1) to Manager (10). It is received by Manager (10) over connection (15) from the IP Network to the Manager. If the Manager detects that a trap message was received whose sequence number was not the number following that of the previously received trap message, the Manager sends a Get message, such as message (40) to Agent (20). The message includes an identification (41) that trap information is requested, i.e., that the Agent is requested to re-transmit the missing trap message. Field (42) of message (40) includes information concerning the sequence number of the missing message, or messages. In response to receipt of a message such as message (40), Agent (20) will generate Get Response message(s) containing the information of the missing trap messages.

The sliding window acknowledgment algorithm along with a priority queue in the Agent, work together to provide reliable SNMP traps with a throttling mechanism and a priority insertion scheme. This throttling mechanism is effective in solving the problem of “trap storms”, (burst of traps sent to the Manager), driving the Manager into an overload state.

The Agent is designed to send a limited number of traps before the, “waiting for an acknowledgment”, from the Manager. This limit is referred to as the window size. Once the Agent has that many traps sent and unacknowledged, it is prohibited from sending more until the Manager allows additional traps to be sent by acknowledging previous traps. During this interval, the Agent temporarily places trap information in a priority queue. When the number of pending traps is less than the window size, the Agent can send more traps. It does this by retrieving the highest priority trap from the priority queue, (even if the highest priority trap was the most recent trap; hence, priority insertion), and sending it. This is repeated until the queue is empty or the window size is again reached.

The Manager is designed to periodically acknowledge traps received from Agents. It is monitoring the window size, (number of trap messages), and duration, (length of time before it needs to acknowledge the traps already received). As the Manager processes traps, if the number of unacknowledged traps equals the window size, the traps are acknowledged by letting the Agent know the sequence number of the last trap processed by the Manager. During times of low activity, the number of traps will not reach the window size for a long time. For those cases, there is a maximum time specified in which the trap must be acknowledged. The Manager will acknowledge all processed traps after that time has passed.

Under high traffic times, the Manager may not be able to process all traps in the maximum time specified. The Agent will then send the unacknowledged traps again. To avoid processing duplicated traps, the Manager should ignore traps with a sequence number less than the expected sequence number.

The Manager must be engineered to hold a number of traps equal to the window size multiplied by the number of Agents. This can be accomplished by adjusting the size of the buffer space in the Manager, the size of the window, or the number of Agents managed by the Manager. The Manager then will be able to withstand busy traffic periods.

It is possible that the Manger will run out of buffer space during prolonged high traffic periods. This can happen because it cannot process all traps in the specified amount of time, and the Agents send the traps again. Rather than throw the incoming traps away, the Manager should throw the oldest traps away, and store the newest ones in the buffer.

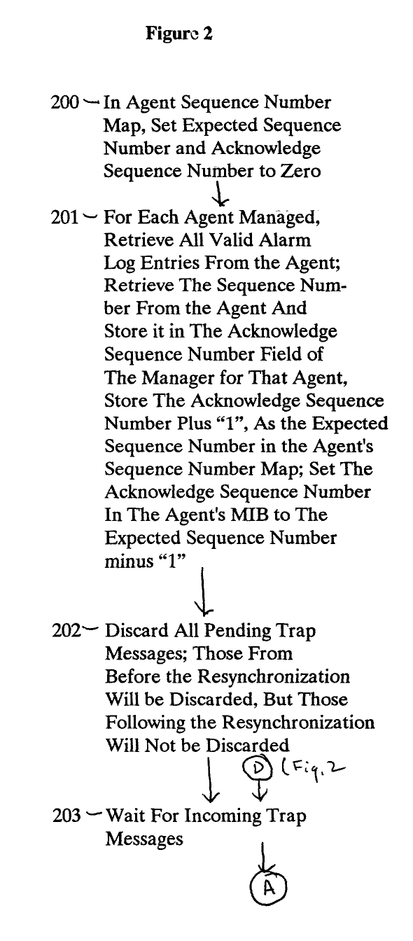

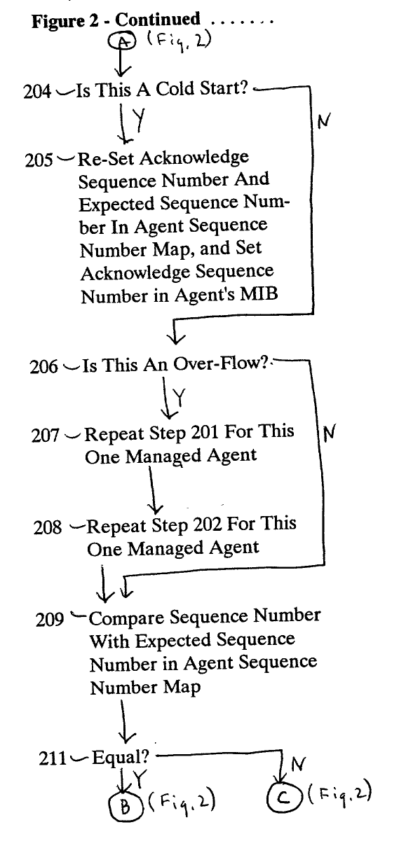

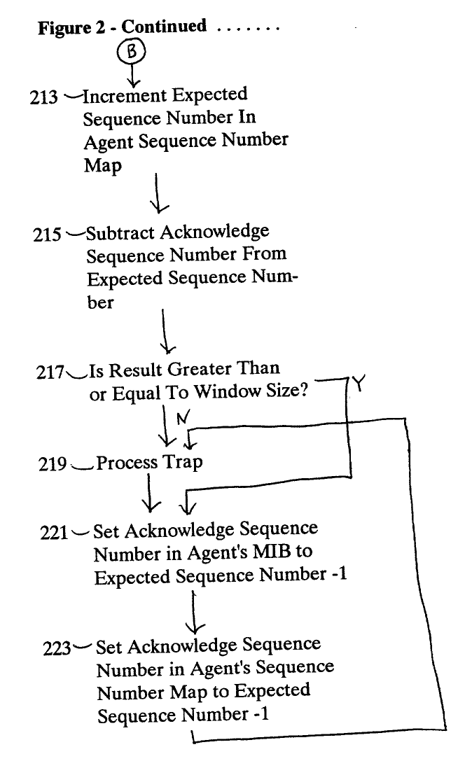

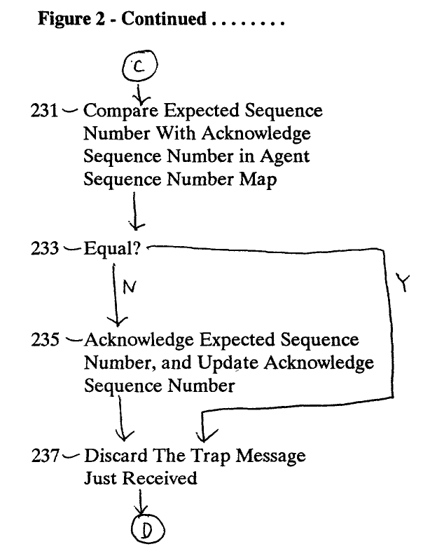

FIG. 2 is a flow diagram of actions performed by the Manager. Initially, the Manager sets the Expected Sequence Number and the Acknowledge Sequence Number to zero in the Agent Sequence Number Table (14), (Action Block 200). For each Agent being managed, retrieve all Alarm Log entries from the Agent, retrieve the sequence number from the Agent, and store it in the “Acknowledge Sequence Number field”, and add “1” and store it in the “Expected Sequence Number” field of the Agent's Sequence Number Map. Also, set the Acknowledge Sequence Number in the Agent's MIB to the Expected Sequence Number minus “1”, (Action Block 201). The Manager then discards all pending trap messages; if these pending trap messages are from before the resynchronization, they will not be sent; if they are the resynchronization, they will be sent, (Action Block 202). The Manager then waits for incoming trap messages (203). Test 204 is used to determine whether this is a cold start trap. If it is a cold start, then Action Block 205 re-sets the Acknowledge Sequence Number and the Expected Sequence Number in the Agent Sequence Number Map, and sends a message to the Agent requesting that the Agent set the Acknowledge Sequence Number (32) in its managed information base (21). Subsequently, Action Block 204, described below is executed.

If this is not a cold start, then Test 206 is used to determine if this is an over-flow. If it is not an over-flow, then Action Block 209 described below is executed. If this is an over-flow, then Step 201, restricted in this case to this one managed Agent, is repeated (Action Block 207). Next, Action Block 202 is repeated again only for this one managed Agent, (Action Block 208).

The Manager then compares the received sequence number of the incoming trap message with the expected sequence number in the Manager's Agent Sequence Number Map for that Agent, (Action Block 209). Test 211 determines if they are equal. If they are equal, (the normal situation), then the Manager increments the expected sequence number in the Agent's Sequence Number Map, (Action Block 213), subtracts the Acknowledge Sequence Number from the Expected Sequence Number, (Action Block 215). Test 217 is used to determine if this difference is equal to or greater than the window size. If not, then the trap message is processed, (Action Block 219), and Action Block 203 is re-entered. If the result of Test 217 indicates that the Expected Sequence Number minus the Acknowledge Sequence Number is equal to or greater than the window size, then the Acknowledge Sequence Number is set via an SNMP message from the Manager in the Agent's MIB, to the Expected Sequence Number −1, (Action Block 221). This action is accomplished as a result of sending a message from the Manager to the Agent. The Acknowledge Sequence Number in the Manager's Agent Sequence Number Map is then set to the Expected Sequence Number −1, (Action Block 223), in order to prepare for the next window interval. Following execution of Action Block 223, Action Block 219 is entered in order to process a trap message, and, subsequently, Action Block 203 is re-entered.

For the case in which the received sequence number is not equal to the expected sequence number in the Agent Sequence Number Map, (negative result of Test 211), then the Expected Sequence Number is compared with the Acknowledge Sequence Number in the Agent Sequence Number Map, (Action Block 231). The comparison of the Expected Sequence Number with the Acknowledged Sequence Number is done so that messages that have already been received in the proper order, but not yet acknowledged, will be acknowledged. Since there was a break in the sequence number, the Agent will be expected to re-transmit traps, but it should not have to retransmit traps that have already been received, accepted and processed. Test 233 is used to determine if the two are equal. If not, (the normal case for missing a message), then the Manager acknowledges the Expected Sequence Number, and updates the Acknowledge Sequence Number. If the result of Test 233 is positive, (e.g., if a message was sent twice), or following the execution of Action Block 235, the trap message that was just received, is discarded (Action Block 237), and Action Block 203, (Wait For Incoming Trap Messages), is re-entered. The message is discarded because, as a result of Test 211, it has been determined that this trap message was received out of sequence. In order to avoid processing trap messages out of sequence, the message is discarded. Since the Agent will not have this or other missing traps acknowledged, it will re-send these traps once the Agent “times-out”.

In case communications between the Manager and an Agent are lost for an extended period of time, following recovery of communications, the Manager checks the overflow status of the Agent. If the status indicates overflow, then a Get or Get-Bulk request is used to retrieve the contents of the Alarm Table. The Agent responds with a Get-Response message. The Get, Get-Bulk, and Get-Response messages are standard SNMP messages.

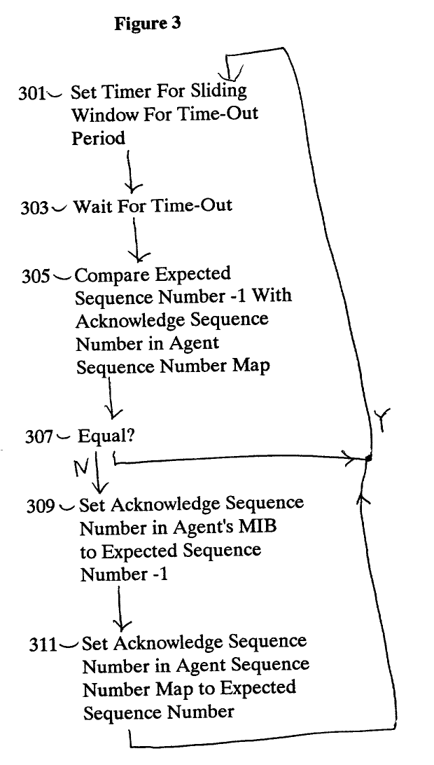

FIG. 3 illustrates the flow for administering the sliding window time-out. The Manager's Timer for the sliding window for a particular Agent is set to the time-out period, (Action Block 301). The Manager waits for time-out, (Action Block 303). Following a time-out, the Expected Sequence Number −1, and the Acknowledge Sequence Number are then compared in the Agent Sequence Number Map, (Action Block 305). Test 307 is used to determine if the two are equal. If they are, Action Block 301 is re-entered. This is the situation in which the maximum number of messages was received during the time-out interval. If the result of Test 307 indicates that the two are not equal, (indicating that messages were received by the Manager, but not yet acknowledged at the moment that the Sliding Window Timer expired), then the Acknowledge Sequence Number in the Agent's MIB is set to the Expected Sequence Number (Action Block 309), by sending a message from the Manager to the Agent. The Acknowledge Sequence Number in the Agent Sequence Number Map of the Manager is set to the Expected Sequence Number −1, (Action Block 311). Following Action Block 311, Action Block 301 is re-entered to set the timer of the sliding window to a new time-out period.

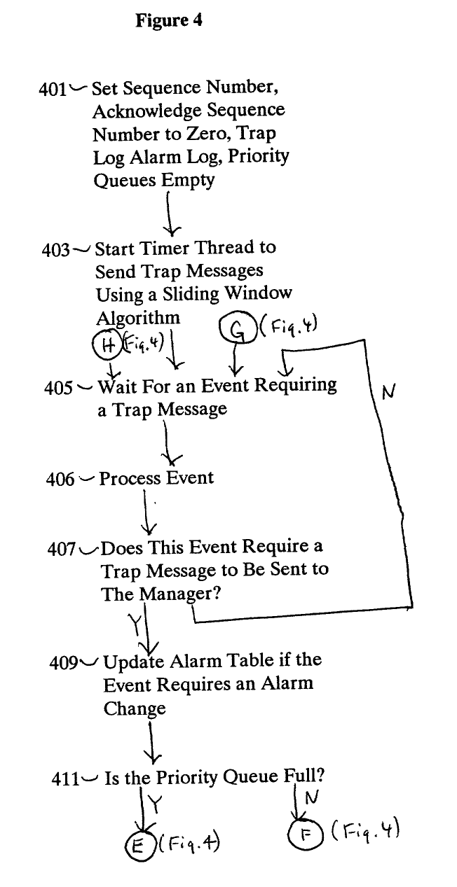

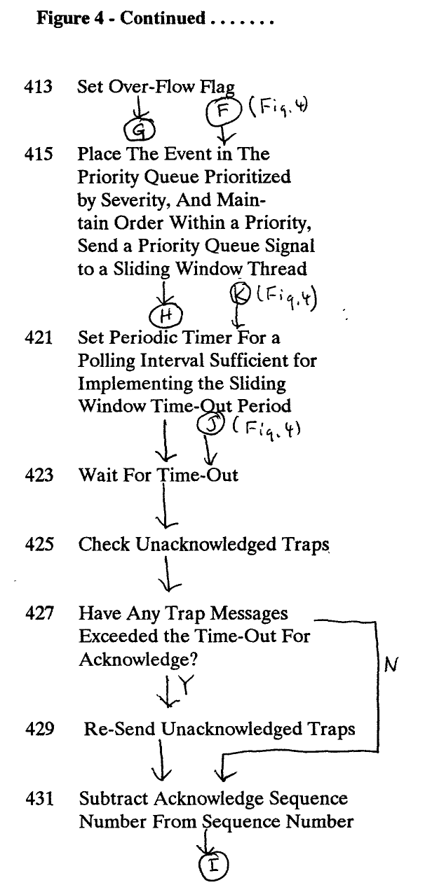

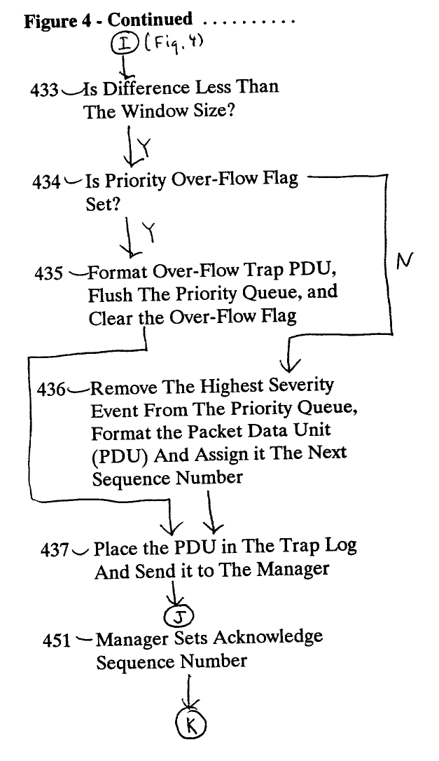

FIG. 4 is a flow diagram illustrating actions performed in the Agent. At initialization time for the Agent, the Sequence Number and Acknowledge Sequence Number are set to zero, the Trap Log, Alarm Log, and Priority Queue are empty, (Action Block 401). This initialization is performed in response to a message from the Manager, the message being sent at the same time that Action Block 200 is executed in the Manager, or to an autonomous action by the Agent. The Agent starts a timer thread to send trap messages under the discipline of the sliding window algorithm, (Action Block 403). The Agent then waits for an event requiring a trap message, (Action Block 405). Following receipt of an event, the Agent professes the event, (Action Block 406). Test 407 is used to determine if an event that requires a trap message to be sent to the Manager has occurred. If this event requires no trap message to be sent to the Manager, then Action Block 405 is re-entered. If an event has occurred requiring the trap message, then the Alarm Table is updated if the event requires an alarm change, (Action Block 409). Test 411 then checks whether the priority queue is full. If the priority queue is full, then an over-flow flag is set, (Action Block 413), and Action Block 405 is re-entered. If the priority queue is not full, then the event is placed in the priority queue, (Action Block 415). The Priority Queue effectively is a plurality of queues, one for each level of priority. Within each level, events are placed in a proper order. A priority queue signal is sent to a thread for managing a sliding window. This thread retrieves information from the priority queue, transmits, or re-transmits trap messages within the constraints defined by a sliding window algorithm, (Action Block 415).

When the periodic timer for the sliding window time-out period has been set (Action Block 421), in response to the starting of a timer thread, (Action Block 403), timing is executed by waiting for a time-out, (Action Block 423). The period is for a polling interval sufficient for implementing the sliding timeout period. For example, the interval might be long enough so that the Manager will process all pending messages within that interval, for the 95th percentile of the number of pending messages. Following the time-out, Action Block 425 tests for any unacknowledged traps. Test 427 determines whether any unacknowledged traps have exceeded the time-out for the acknowledgment. If so, then any unacknowledged traps are sent, (Action Block 429). Following the execution of Action Block 429, or if no unacknowledged traps have exceeded the time-out, then Action Block 431 is entered. Action Block 431 subtracts the Acknowledge Sequence Number from the Sequence Number. If this difference is not less than the window size, then the Action Block 421 is re-entered to set the timer for the time-out period. If the result of the subtraction is less than the window size, (positive result of Test 433), then Test 434 is used to determine whether the priority queue over-flow flag is set. If that flag is set, then an over-flow trap Packet Data Unit (PDU) is formatted. The priority queue is flushed, and the over-flow flag is cleared, (Action Block 435). Subsequently, Action Block 437 described below is executed. If the result of Test 434 is negative, i.e., if the priority queue over-flow flag is not set, then the highest severity event is removed from the priority queue, a Packet Data Unit (PDU) is formatted, and that PDU is assigned the next sequence number, (Action Block 436). Following the execution of either Action Blocks 435 or 436, the PDU is placed in the Trap Log and sent to the Manager, (Action Block 437). Following the execution of Action Block 437, or a negative result of Test 433, Action Block 421 is re-entered. In the case of a negative result of Test 433, the PDU is first placed in the queue.

When the Agent receives a Set message to set the Acknowledge Sequence Number (Action Block 451), the Agent sets the periodic timer, (Action Block 421).

The above description is one preferred embodiment of Applicants' invention. Many other embodiments can be derived by those of ordinary skill in the art without departing from the scope of the invention. The invention is limited only by the attached claims.

1. In a broad based data network, a method of transmitting trap messages from an Agent system to a Manager system, comprising the steps of:
in the Agent system, associating a sequence number with each trap message;
transmitting trap messages to said Manager system in accordance with said sequence numbers;
if said Manager system recognizes that a trap message was received, whose sequence number does not directly follow the sequence number of the most recently received trap message from said Agent, said Manager system requesting re-transmission of a trap message associated with a missing sequence number;
said Agent system re-transmitting said trap message with said missing sequence number.

2. The method of claim 1, further comprising the steps of:
saving trap messages for reporting alarm conditions in said Agent System;
responsive to detection of an overload condition, discarding trap messages that do not represent alarm conditions; and
responsive to detection that said overload condition is being relieved, transmitting trap messages for all saved alarm conditions.

3. The method of claim 2, further comprising the step of saving each alarm condition until the alarm condition is no longer active.

4. The method of claim 1, further comprising a throttling scheme for limiting the number of trap messages transmitted from said Agent system to said Manager system, comprising the steps of:
in response to receipt of an Acknowledge Message from said Manager system, said Agent system opening a window for the transmission of N trap messages;
transmitting up to N trap messages; and
deferring transmission of additional messages until an additional acknowledgment message is received from said Manager system.

5. The method of claim 1, further comprising the step of:
in response to receipt of N consecutive trap messages having correct sequence numbers, transmitting an acknowledgment message comprising a sequence number of a last received trap message to said Agent system.

6. The method of claim 5, further comprising the steps of:
responsive to a time-out, sending an acknowledgment message having a sequence number related to a last received message to said Agent system;
said Agent system responsive to receipt of said acknowledgment message for opening a window to allow N trap messages to be sent to said Manager system.

7. In a broad based data network, apparatus for transmitting trap messages from an Agent system to a Manager system, comprising:
processor means in said Agent system, operative under program control for executing the steps of:
associating a sequence number with each trap message;
transmitting trap messages to said Manager system in accordance with said sequence numbers;
processor means in said Manager system operative under program control for executing the steps of:
if said Manager system recognizes that a trap message was received whose sequence number does not directly follow the sequence number of the most recently received trap message from said Agent, said Manager system requesting re-transmission of a trap message associated with a missing sequence number;
said processor means in said Agent system for further executing the steps of:
re-transmitting said trap message with said missing sequence number.

8. The apparatus of claim 7, said processor means in said Agent system for further executing the steps of:
saving trap messages for reporting alarm conditions in said Agent System;
responsive to detection of an overload condition, discarding trap messages that do not represent alarm conditions; and
responsive to detection that said overload condition is being relieved, transmitting trap messages for all saved alarm conditions.

9. The apparatus of claim 8, wherein said processor means in said Agent system for further executing the step of saving each alarm condition until the alarm condition is no longer active.

10. The apparatus of claim 7, wherein said processor means in said Agent system for limiting the number of trap messages transmitted from said Agent system to said Manager system by further executing the steps of:
in response to receipt of an Acknowledge Message from said Manager system, said Agent system opening a window for the transmission of N trap messages;
transmitting up to N trap messages; and
deferring transmission of additional messages until an additional acknowledgment message is received from said Manager system.

11. The apparatus of claim 7, said processor means in said Manager system for further executing the step of:
in response to receipt of N consecutive trap messages having correct sequence numbers, transmitting an acknowledgment message comprising a sequence number of a last received trap message to said Agent system.

12. The apparatus of claim 11, said processor means in said Manager system for further executing the step of:
responsive to a time-out, sending an acknowledgment message having a sequence number related to a last received message to said Agent system; and
said processor means in said Agent system for executing the step of:
responsive to receipt of said acknowledgment message, opening a window to allow N trap messages to be sent to said Manager system.
